(19) United States
(12) Patent Application Publication
(10) Pub. No.: US 2026/0352011 A1
(43) Pub. Date: Nov. 5, 2026

(54) All-Solid-State Battery and Method for Controlling All-Solid-State Battery

(71) Applicants: Nissan Motor Co., Ltd., Yokohama-shi, Kanagawa (JP); Renault S.A.S., Boulogne- Billancourt (FR)

(72) Inventor: Keiji Okada, Kanagawa (JP)

(21) Appl. No.: 19/118,682

(22) PCT Filed: Oct. 12, 2022
(86) PCT No.: PCT/IB2022/000579

§ 371 Date: Apr. 4, 2025

(51) Int. Cl. H02J 7/90; H01M 10/44; H02J 7/80

(52) U.S. Cl. CPC H02J 7/977; H01M 10/443; H02J 7/80; H01M 2220/20

(57) ABSTRACT

This method for controlling an all-solid-state battery comprises: a step for discharging a battery cell while constraining the battery cell at a first constraint pressure when the temperature of the battery cell is higher than or equal to a first temperature set in advance and lower than a second temperature set in advance; and a step for reducing the constraint pressure of the battery cell to a second constraint pressure lower than the first constraint pressure when the temperature of the battery cell is higher than or equal to the second temperature.

### TECHNICAL FIELD

The present invention relates to an all-solid-state battery and a method for controlling an all-solid-state battery.

### BACKGROUND ART

There is known a battery configured such that an operation thereof is controlled according to a temperature.

For example, Patent Literature 1 (JP2013-20891A) discloses an invention related to a restraint structure of an assembled battery. In this invention, a control unit acquires temperature information of the assembled battery and compares a detected actual measured temperature with a reference temperature stored in advance, and when the actual measured temperature is higher than the reference temperature, a command of “lowering a restraint pressure” is output from the control unit to a restraint pressure variable device, and a restraint pressure of a restraint band is adjusted based on the command.

On the other hand, Patent Literature 2 (JP2002-141112A) discloses a battery device characterized in that when a temperature sensor detects a temperature of an external surface or an internal atmosphere of a battery storage unit set in advance, the battery is discharged to a capacity equal to or less than a predetermined ratio of a reference capacity.

### SUMMARY OF INVENTION

The present inventors have studied an all-solid-state battery. The all-solid-state battery is a secondary battery using a solid electrolyte. Among all-solid-state batteries, in particular, an all-solid-state battery having a negative electrode containing metal lithium has been studied. In such an all-solid-state battery, when the temperature becomes abnormally high, the metal lithium may melt. The metal lithium has high reactivity. Therefore, even when the temperature becomes abnormally high, it is desired to prevent leakage of molten metal lithium.

Patent Literatures 1 and 2 do not describe an all-solid-state battery having a negative electrode containing metal lithium. Therefore, an object of the present invention is to provide an all-solid-state battery capable of preventing metal lithium from leaking to the outside even when the temperature becomes abnormally high, and a control method thereof.

### BRIEF DESCRIPTION OF DRAWINGS

FIG. 1 is a block diagram illustrating a schematic configuration of an all-solid-state battery according to a first embodiment.

FIG. 2 is a flowchart illustrating a method for controlling an all-solid-state battery according to the first embodiment.

FIG. 3 is a schematic block diagram illustrating an all-solid-state battery according to a second embodiment.

FIG. 4 is a flowchart illustrating a method for controlling an all-solid-state battery according to the second embodiment.

FIG. 5 is a diagram schematically illustrating a relation among control contents of the all-solid-state battery, a charge amount, and a temperature of a battery cell.

FIG. 6 is a schematic diagram illustrating an example of the battery cell according to the second embodiment.

### DESCRIPTION OF EMBODIMENTS

Hereinafter, embodiments of the present invention will be described with reference to the drawings.

### 1: First Embodiment

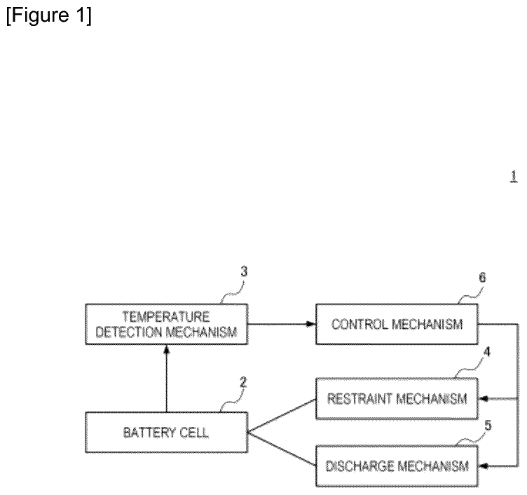

FIG. 1 is a block diagram illustrating a schematic configuration of an all-solid-state battery 1 according to a first embodiment. The all-solid-state battery 1 according to the present embodiment is, for example, a secondary battery to be mounted on a vehicle or the like.

As illustrated in FIG. 1, the all-solid-state battery 1 includes a battery cell 2, a temperature detection mechanism 3, a restraint mechanism 4, a discharge mechanism 5, and a control mechanism 6.

The battery cell 2 is a part that implements charging and discharging functions. Although not illustrated, the battery cell 2 includes a solid electrolyte, a positive electrode, and a negative electrode. The negative electrode contains lithium metal. In the battery cell 2, during charge, lithium ions move from the positive electrode to the negative electrode via the solid electrolyte, and the lithium metal is precipitated on the negative electrode. On the other hand, during discharge, the lithium metal of the negative electrode moves to a positive electrode side as lithium ions and is occluded in the positive electrode. That is, during discharge, the lithium metal is lost from the negative electrode. The battery cell 2 included in the all-solid-state battery 1 may be single or plural.

The restraint mechanism 4 is configured to restrain (pressurize) the battery cell 2. In order to obtain desired battery characteristics in the all-solid-state battery 1, each electrode must be firmly bonded to the solid electrolyte. Therefore, the battery cell 2 is restrained by the restraint mechanism 4 so that each electrode is firmly bonded to the solid electrolyte. When a plurality of battery cells 2 are provided, the plurality of battery cells 2 are restrained by the restraint mechanism 4.

The restraint mechanism 4 is also provided for vibration resistance. That is, vibration resistance of the battery cell 2 is imparted by the restraint mechanism 4. For example, when the all-solid-state battery 1 is mounted on a vehicle, vibration of the vehicle may be applied to the battery cell 2. Members included in the battery cell 2 may be dispersed due to the vibration. When a plurality of battery cells 2 are provided, the plurality of battery cells 2 may be dispersed due to vibration. On the other hand, since the battery cell 2 is restrained by the restraint mechanism 4, dispersion or the like of constituent members is prevented even when the vibration is applied.

The restraint mechanism 4 is configured to be able to adjust a restraint pressure.

A specific configuration of the restraint mechanism 4 is not particularly limited. For example, the restraint mechanism 4 can be implemented by a pair of end plates disposed to sandwich the battery cell 2 in a stacking direction and an actuator configured to be able to pressurize and restrain the battery cell 2 by the pair of end plates.

The discharge mechanism 5 is configured to discharge the battery cell 2. The discharge mechanism 5 can be implemented by, for example, a load circuit connected to the battery cell 2.

The temperature detection mechanism 3 is configured to detect a temperature of the battery cell 2 to generate temperature data. Specifically, the temperature detection mechanism 3 detects a temperature of the negative electrode of the battery cell 2. The temperature detection mechanism 3 may be configured to directly or indirectly measure the temperature of the battery cell 2. For example, the temperature detection mechanism 3 may be configured to indirectly obtain the temperature of the battery cell 2 by measuring the temperature at a position slightly away from the battery cell 2.

The control mechanism 6 acquires the temperature data from the temperature detection mechanism 3 and controls the operation of the all-solid-state battery 1 based on the acquired temperature data. The control mechanism 6 is implemented by, for example, a computer such as a microcomputer. That is, the control mechanism 6 includes a storage device such as a memory that stores a control program and a computing device such as a CPU that executes the control program. In the control mechanism 6, the computing device executes the control program to implement the function. Specifically, the control mechanism 6 is programmed to control the operation of the all-solid-state battery 1 so that the molten metal lithium does not leak even when the battery cell 2 is abnormally heated to a high temperature.

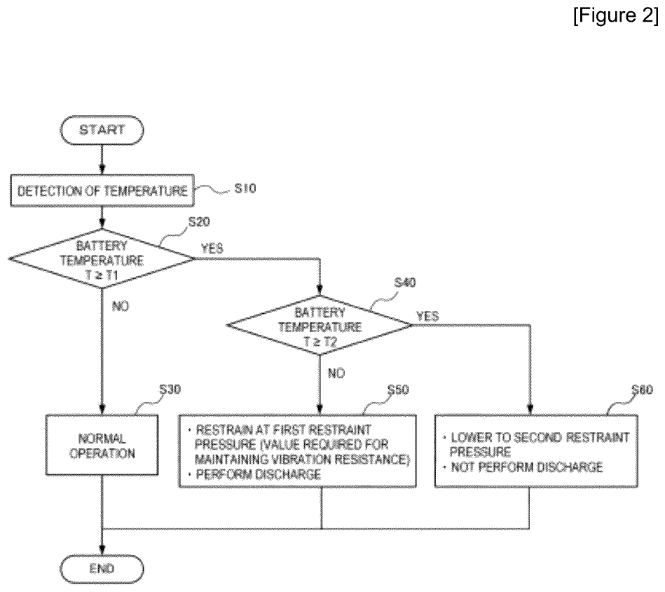

FIG. 2 is a flowchart illustrating a method for controlling the all-solid-state battery 1 to be executed by the control mechanism 6. Hereinafter, the method for controlling the all-solid-state battery 1 will be described in detail with reference to FIG. 2.

### (Step S10)

First, the control mechanism 6 detects a temperature of the battery cell 2. That is, the control mechanism 6 acquires temperature data from the temperature detection mechanism 3.

### (Step S20)

When the temperature data is acquired, the control mechanism 6 compares the temperature of the battery cell 2 with a preset first temperature T1. The first temperature T1 is a temperature as a criterion for determining whether the battery is in an abnormal temperature rise state. The first temperature T1 is set within a range of, for example, 100 °C to 150 °C. The first temperature T1 may be, for example, a temperature at which the control mechanism 6 determines that the battery is in the abnormal temperature rise state and a user is notified of the abnormal temperature rise state via a notification mechanism such as a lamp.

### (Step S30)

When the temperature of the battery cell 2 is lower than the first temperature T1, it can be said that the battery is in a normal state. Therefore, the control mechanism 6 does not perform any particular process. That is, the all-solid-state battery 1 is operated by a normal operation.

### (Step S40)

On the other hand, when the temperature of the battery cell 2 is equal to or higher than the first temperature T1, the control mechanism 6 further compares the temperature of the battery cell with a second temperature T2. The second temperature T2 is a temperature higher than the first temperature T1, and is a temperature set from the viewpoint of determining whether the lithium metal melts. The second temperature T2 is set to a value within a range of, for example, 150 °C to 210 °C, preferably 160 °C to 200°C.

### (Step S50)

When the temperature of the battery cell 2 is lower than the second temperature T2 in step S40, the control mechanism 6 causes the discharge mechanism 5 to discharge the battery cell 2 while causing the restraint mechanism 4 to restrain the battery cell 2 at a first restraint pressure.

The first restraint pressure may be a magnitude at which the vibration resistance of the battery cell 2 is maintained. The first restraint pressure may be the same as the restraint pressure in the normal operation (step S30), but may be different from the restraint pressure in the normal operation as long as the vibration resistance is maintained. In either case, since the restraint pressure to some extent is maintained, the vibration resistance of the battery cell 2 is ensured.

On the other hand, by discharging the battery cell 2 in this step, the lithium metal present in the negative electrode moves to a positive electrode side and is occluded in the positive electrode. The lithium occluded in the positive electrode usually does not melt. That is, by performing discharging, the amount of the lithium metal that may be melted is reduced before the temperature of the battery cell 2 reaches a melting temperature of the lithium metal.

### (Step S60)

On the other hand, when the temperature of the battery cell 2 is equal to or higher than the second temperature T2 in step S40, the control mechanism 6 lowers the restraint pressure of the battery cell 2 by the restraint mechanism 4 to a second restraint pressure lower than the first restraint pressure. When the temperature of the battery cell 2 is equal to or higher than the second temperature T2, it is considered that the lithium metal is melted. When the battery cell 2 is restrained by a strong force in a state where the lithium metal is melted, the molten lithium metal is likely to leak to the outside of the battery cell 2. In contrast, by lowering the restraint pressure in this step, the lithium metal is less likely to leak to the outside even when the lithium metal is melted.

The second restraint pressure may be lower than the restraint pressure (first restraint pressure) in step S50. Preferably, the second restraint pressure is substantially zero. That is, the control mechanism 6 controls the restraint mechanism 4 so that the restraint pressure of the battery cell 2 is released.

The discharge operation cannot be performed in a state where the lithium metal is melted. Therefore, in step 60, the control mechanism 6 does not perform the discharge operation.

The first embodiment has been described above. In the present embodiment, an aspect has been described in which the normal operation (step S3) is performed when the temperature of the battery cell 2 is equal to or lower than the first temperature T1. However, even in a case where the temperature of the battery cell 2 is equal to or lower than the first temperature T1, when the temperature approaches the first temperature T1 to some extent, input and output of the battery cell 2 may be limited by the control mechanism 6.

Hereinafter, a representative relation between the configuration and the operation and effect of the present embodiment will be summarized.

The all-solid-state battery 1 according to the present embodiment includes the battery cell 2 having a negative electrode containing lithium metal, the restraint mechanism 4 configured to restrain the battery cell, the discharge mechanism 5 configured to discharge the battery cell 2, the temperature detection mechanism 3 configured to detect a temperature of the battery cell 2 to generate temperature data, and the control mechanism 6 configured to control operations of the restraint mechanism 4 and the discharge mechanism 5 based on the temperature data. When the temperature of the battery cell 2 is equal to or higher than the preset first temperature T1 and lower than the preset second temperature T2, the control mechanism 6 causes the discharge mechanism 5 to discharge the battery cell 2 while causing the restraint mechanism 4 to restrain the battery cell 2 at a first restraint pressure. When the temperature of the battery cell 2 is equal to or higher than the second temperature T2, the control mechanism 6 is configured to lower a restraint pressure by the restraint mechanism 4 to a second restraint pressure lower than the first restraint pressure.

A method for controlling an all-solid-state battery according to the present embodiment is a method for controlling the all-solid-state battery 1 that includes the battery cell 2 having a negative electrode containing lithium metal and is configured to restrain the battery cell 2. This control method includes a step of detecting a temperature of the battery cell 2 (step S10) and a step of controlling an operation of the battery cell 2 based on the temperature of the battery cell 2 (steps S50 and S60). The controlling step (steps S50 and S60) includes a step (step S50) of discharging the battery cell 2 while restraining the battery cell 2 at a first restraint pressure when the temperature of the battery cell 2 is equal to or higher than the preset first temperature T1 and lower than the preset second temperature T2, and a step (step S60) of lowering a restraint pressure of the battery cell 2 to a second restraint pressure lower than a first restraint pressure when the temperature of the battery cell 2 is equal to or higher than the second temperature T2.

According to the all-solid-state battery 1 and the control method thereof described above, when the temperature of the battery cell 2 becomes equal to or higher than the first temperature T1, the battery cell 2 is discharged, and thus the amount of lithium metal that may leak during melting is reduced in advance. Therefore, even when the temperature thereafter reaches a temperature at which the lithium metal melts, leakage of the lithium metal is prevented.

When the temperature of the battery cell 2 is equal to or higher than the first temperature T1 and lower than the second temperature T2, the restrained state of the battery cell 2 is maintained at the first restraint pressure. Accordingly, even when the temperature of the battery cell 2 becomes abnormally high, the vibration resistance is maintained until the lithium metal is melted.

On the other hand, when the temperature of the battery cell 2 is higher than the second temperature T2, the restraint pressure of the battery cell 2 is lowered to the second restraint pressure. Accordingly, even when the lithium metal is melted, the molten lithium metal is hardly extruded, and leakage to the outside is prevented.

### 2: Second Embodiment

Next, a second embodiment will be described. As for a matter that a same configuration as that of the first embodiment can be adopted, a description thereof is omitted.

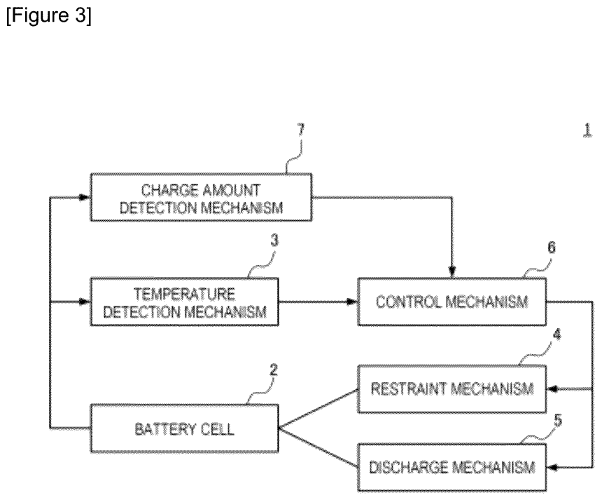

FIG. 3 is a schematic block diagram illustrating the all-solid-state battery 1 according to the second embodiment. In the present embodiment, a charge amount detection mechanism 7 is added to the first embodiment.

The charge amount detection mechanism 7 is configured to detect a charge amount (for example, SOC) of the battery cell 2. The expression of “detect a charge amount” also includes detecting the charge amount by “estimation”. For example, the charge amount detection mechanism 7 may detect the charge amount by estimating the SOC of the battery cell 2 from a voltage or the like. The charge amount detection mechanism 7 is configured to generate charge amount data indicating the detected charge amount and notify the control mechanism 6 of the charge amount data.

The control mechanism 6 controls operations of the restraint mechanism 4 and the discharge mechanism 5 with reference to the charge amount data acquired from the charge amount detection mechanism 7 in addition to the temperature data acquired from the temperature detection mechanism 3. Hereinafter, a method for controlling the all-solid-state battery 1 implemented by the control mechanism 6 will be described in detail.

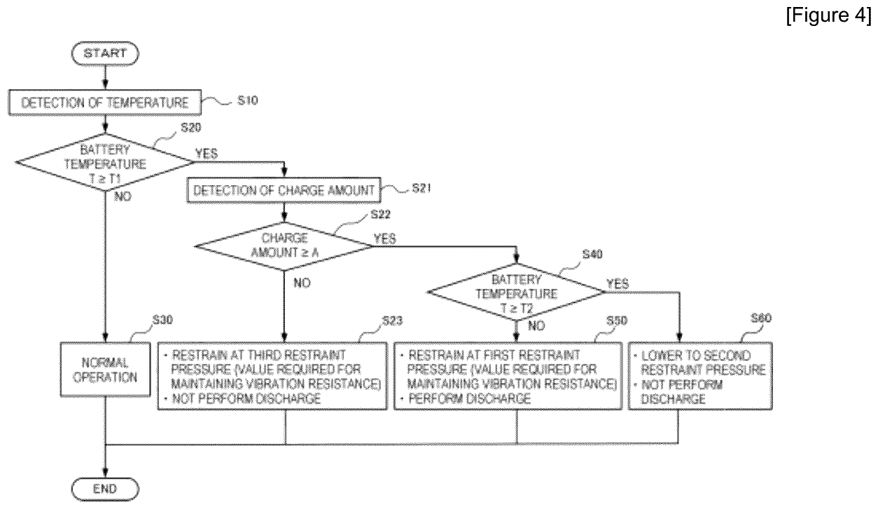

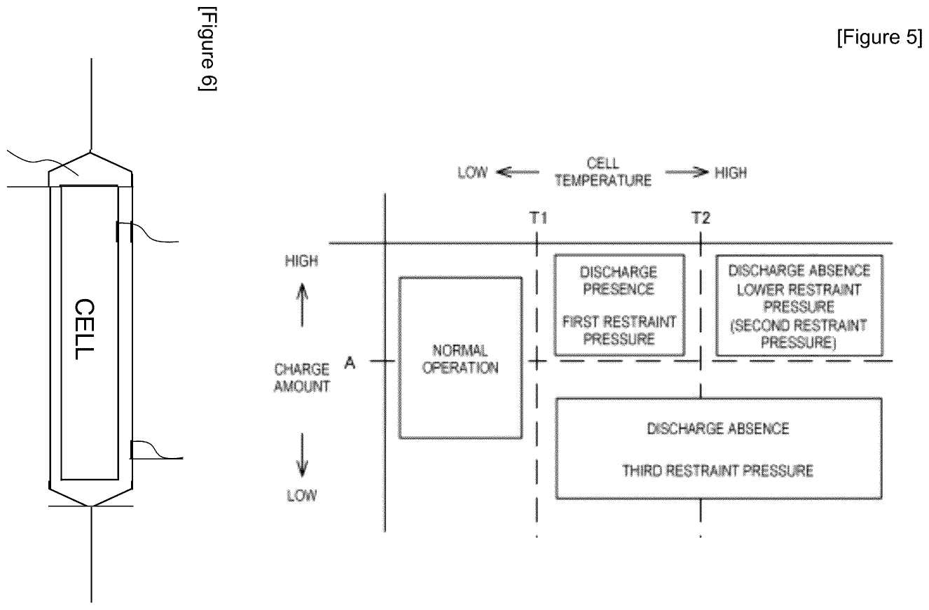

FIG. 4 is a flowchart illustrating the method for controlling the all-solid-state battery 1 according to the present embodiment. FIG. 5 is a diagram schematically illustrating a relation among control contents of the all-solid-state battery 1, the charge amount, and the temperature of the battery cell 2. In the present embodiment, processes of steps S21 to 23 are added to the first embodiment.

### (Steps S10 to 30)

Steps S10 to 30 are the same as in the first embodiment. That is, in step S10, the control mechanism 6 detects a temperature of the battery cell 2 (step S10). Then, the control mechanism 6 compares the temperature of the battery cell 2 with the first temperature T1 (step S20). When the temperature of the battery cell 2 is lower than the first temperature T1, the control mechanism 6 causes the all-solid-state battery 1 to operate in a normal operation (step S30).

### (Steps S21 and 22)

On the other hand, when the temperature of the battery cell 2 is equal to or higher than the first temperature T1, a charge amount of the battery cell 2 is detected. That is, the control mechanism 6 acquires charge amount data via the charge amount detection mechanism 7 (step S21). Then, the control mechanism 6 compares the charge amount of the battery cell 2 with a preset first charge amount A (%) (step S22).

### (Steps S40 to 60)

Operations when the charge amount of the battery cell 2 is equal to or more than the first charge amount A are the same as steps S40 to 60 in the first embodiment. That is, the control mechanism 6 compares the temperature of the battery cell 2 with the second temperature T2 (step S40). When the temperature of the battery cell 2 is lower than the second temperature T2, the control mechanism 6 causes the discharge mechanism 5 to discharge the battery cell 2 until the charge amount of the battery cell 2 is less than the first charge amount A while causing the restraint mechanism 4 to restrain the battery cell 2 at a first restraint pressure (step S50). On the other hand, when the temperature of the battery cell 2 is equal to or higher than the second temperature T2, the control mechanism 6 lowers the battery cell 2 to a second restraint pressure by the restraint mechanism 4. A discharge operation by the discharge mechanism 5 is not performed (step S60).

### (Step S23)

On the other hand, when the charge amount of the battery cell 2 is less than the first charge amount A in step S22, the control mechanism 6 controls the restraint mechanism 4 to restrain the battery cell 2 at a third restraint pressure. The third restraint pressure is a pressure at which vibration resistance is maintained, and is a value larger than the second restraint pressure. The third restraint pressure may be the same as or different from the first restraint pressure. The control mechanism 6 does not perform a discharge process.

The method for controlling the all-solid-state battery 1 according to the second embodiment has been described above. According to the present embodiment, when the charge amount of the battery cell 2 exceeds the first charge amount A, the operation of the all-solid-state battery 1 is controlled as in the first embodiment. Accordingly, leakage of molten lithium metal is prevented as in the first embodiment.

On the other hand, when the charge amount of the battery cell 2 is small (that is, when the charge amount is less than the first charge amount A), the battery cell 2 cannot be discharged even when the temperature of the battery cell 2 is equal to or higher than the first temperature T1 (step S23). Therefore, a certain amount of electric power is secured. For example, in a case where the all-solid-state battery 1 is mounted on a vehicle, when the discharge process is performed at the time of abnormal temperature rise and the electric power of the battery cell 2 is completely lost, the electric power required for vehicle evacuation or the like may not be secured. In contrast, according to the present embodiment, since the discharge process is not performed when the charge amount is less than the first charge amount A, a certain amount of electric power is secured for vehicle evacuation or the like. When the charge amount of the battery cell 2 is small, the amount of the lithium metal that may be melted is small, and thus even when the temperature of the battery cell 2 reaches the melting temperature of the lithium metal thereafter, the possibility that the lithium metal leaks is low.

In the present embodiment, in a case where the charge amount of the battery cell 2 is less than the first charge amount A, the battery cell 2 is restrained at a restraint pressure (third restraint pressure) that ensures vibration resistance even when the temperature is higher than the second temperature T2. As described above, when the charge amount of the battery cell 2 is less than the first charge amount A, it can be said that the amount of lithium metal that may be melted is small. Therefore, the possibility that the lithium metal leaks to the outside is low even when the battery cell 2 is restrained. Since the battery cell 2 is restrained at the third restraint pressure under the condition where the possibility of leakage is low, the vibration resistance is ensured.

The first charge amount A is set to a value such that the amount of lithium metal contained in the negative electrode does not leak to the outside. This point will be specifically described below.

FIG. 6 is a schematic diagram illustrating an example of the battery cell 2 according to the present embodiment. The battery cell 2 is accommodated in a film-shaped exterior body 8. In the exterior body 8, a buffer space 9 is provided between the exterior body 8 and the battery cell 2. With such a configuration, even when some lithium metal is melted, the molten lithium metal is accommodated in the buffer space 9 and does not reach the outside of the exterior body 8.

Here, as described above, the amount of the lithium metal that may be melted, that is, the amount of the lithium metal contained in the negative electrode changes according to charge and discharge states of the battery cell 2. Specifically, the amount of lithium metal contained in the negative electrode increases during charging, and the amount of lithium metal decreases during discharging. Therefore, the first charge amount A is set to a charge amount such that the amount of lithium metal contained in the negative electrode is an amount enabling accommodation in the buffer space 9. When the first charge amount A is set to such a value, the charge amount of the battery cell 2 is reduced such that the amount of lithium metal contained in the negative electrode falls within a range enabling accommodation in the buffer space 9 when the temperature of the battery cell 2 abnormally rises (when the temperature is higher than the first temperature T1). Therefore, even when the temperature thereafter reaches the temperature at which the lithium metal melts, the molten lithium metal can be accommodated in the buffer space 9, and leakage to the outside can be prevented.

More preferably, the first charge amount A is set to a maximum value of charge amounts such that the amount of lithium metal precipitated on the negative electrode is an amount enabling accommodation in the buffer space 9. When the first charge amount A is set to such a value, the vibration resistance is maintained to the maximum as long as the amount of lithium metal in the negative electrode falls within the amount that fits into the buffer space 9. In addition, electric power can be used until the temperature reaches the temperature (second temperature T2) at which the lithium metal melts.

Although the embodiments of the present invention have been described above, the above embodiments merely exemplify some of application examples of the present invention and do not intend to limit the technical scope of the present invention to the specific configurations of the above embodiments.

1. A control method for controlling an all-solid-state battery that includes a battery cell having a negative electrode containing lithium metal and that is configured to restrain the battery cell, the control method comprising:
a step of detecting a temperature of the battery cell; and
a step of controlling an operation of the all-solid-state battery based on the temperature of the battery cell, the step of controlling including:
a step of discharging the battery cell while restraining the battery cell at a first restraint pressure when the temperature of the battery cell is equal to or higher than a preset first temperature T1 and lower than a preset second temperature T2; and
a step of lowering a restraint pressure of the battery cell to a second restraint pressure lower than the first restraint pressure when the temperature of the battery cell is equal to or higher than the preset second temperature T2.

2. The control method according to claim 1, further comprising:
a step of determining that the battery cell is in an abnormal temperature rise state when the temperature of the battery cell is higher than the preset first temperature T1.

3. The control method according to claim wherein the preset second temperature T2 is a value within a range of 150 °C to 210 °C.

4. The control method according to claim 1-or further comprising:
a step of detecting a charge amount of the battery cell, wherein
the step of controlling further includes a step of restraining, in a case where the charge amount of the battery cell is less than a preset first charge amount A, the battery cell at a third restraint pressure higher than the second restraint pressure without discharging the battery cell even when the temperature of the battery cell is equal to or higher than the preset first temperature T1.

5. The control method according to claim 4, wherein
the battery cell is configured such that lithium metal is precipitated on the negative electrode during charge and the lithium metal is lost from the negative electrode during discharge,
the all-solid-state battery further includes an exterior body configured to accommodate the battery cell,
a buffer space configured to, when the lithium metal is melted, accommodate molten lithium metal provided inside the exterior body, and
the preset first charge amount A is a charge amount where an amount of the lithium metal precipitated on the negative electrode can be accommodated in the buffer space.

6. The control method according to claim 5, wherein the preset first charge amount A is a maximum value of charge amount where the amount of the lithium metal precipitated on the negative electrode can be accommodated in the buffer space.

7. An all-solid-state battery comprising:
a battery cell including a negative electrode containing lithium metal;
a restraint mechanism configured to restrain the battery cell;
a discharge mechanism configured to discharge the battery cell;
a temperature detection mechanism configured to detect a temperature of the battery cell to generate temperature data; and
a control mechanism configured to control operations of the restraint mechanism and the discharge mechanism based on the temperature data,
wherein the control mechanism is configured to:
cause the discharge mechanism to discharge the battery cell while causing the restraint mechanism to restrain the battery cell at a first restraint pressure when the temperature of the battery cell is equal to or higher than a preset first temperature T1 and lower than a preset second temperature T2; and
lower a restraint pressure by the restraint mechanism to a second restraint pressure lower than the first restraint pressure when the temperature of the battery cell is equal to or higher than the preset second temperature T2.
